(19) United States
(12) Patent Application Publication
(10) Pub. No.: US 2025/0190890 A1
(43) Pub. Date: Jun. 12, 2025

(54) System and Method Incorporating Mobile Devices for Safety and/or Industrial Operations

(71) Applicant: Suncor Energy Inc., Calgary (CA)

(72) Inventors: Andrea HINE, Calgary (CA); Jon CARTY, Calgary (CA); Ricardo MALDONADO, Calgary (CA); Ricardo De OLIVEIRA ROMERO, Calgary (CA)

(73) Assignee: Suncor Energy Inc., Calgary (CA)

(21) Appl. No.: 18/976,518

(22) Filed: Dec. 11, 2024

(30) Foreign Application Priority Data
Dec. 11, 2023 (CA) 3222558

(51) Int. Cl. G06Q 10/0631

(52) U.S. Cl. CPC G06Q 10/06311; G06Q 10/06316

(57) ABSTRACT

A system, method, and computer readable medium for performing safety or industrial adjustments in a site, such as a hazardous environment, is disclosed. The method includes transmitting, from the one or more mobile devices, data structures that represent a location of the respective mobile device. The method includes receiving, by a remote system, the transmitted data structures. The method includes providing, to the remote system, one or more additional data structures associated with a project. The method includes determining, based on the data structures and the one or more additional data structures, that one or more coordination criterion have been breached. The coordination criteria are associated with adverse outcomes for the project. The method includes determining a new action to address adverse outcomes associated with the breached criterion, and generating and transmitting at least one view of the new action for approval.

### CROSS-REFERENCE TO RELATED APPLICATION(S)

This application claims priority to Canadian Patent Application No. 3,222,558 filed on Dec. 11, 2023, the contents of which are incorporated herein by reference in their entirety.

### TECHNICAL FIELD

The following relates to safety and industrial systems that incorporate mobile device(s), and in particular to making adjustments based on those device(s).

### BACKGROUND

To date, particularly in industrial applications, industrial and safety systems have not been able to incorporate mobile devices. Mobile device adoption did not occur for a variety of reasons, including, for example, an inability of the mobile devices to safely function in the operating environments; an inability of the mobile devices to function in the desired manner; difficulty in integrating mobile devices with existing system infrastructure; the expense associated with operating, acquiring, or implementing solutions based on integrating mobile devices; difficulty in implementing redundancy, fail safe, or safe fail solutions that incorporate mobile device(s); difficulty in managing confidential information flow to enable industrial or safety applications, etc.

### SUMMARY

In an aspect, this disclosure relates to operating mobile devices in hazardous environments to provide an enterprise with data structures related to the hazardous environment and/or the operator of the mobile device. The data structures can be structured for consumption by a variety of architectures within the enterprise, including, for example, a scheduler architecture (e.g., data from a field mobile device is correlated with, for example, weather data, geolocation data, corrective action data proprietary to the enterprise, etc., to generate work execution plans for front line supervision), a review architecture (e.g., a reviewer can generate or update an inspection test plan, an execution plan, an inspection review plan, or safety suggestions relating to turnaround maintenance or regular base maintenance), an emergency architecture (e.g., data from a field mobile device can be correlated with permit, geolocation, operation information in a visualisation to alert workers with field mobile devices of an emergency event & next actions based on field mobile device geolocation), etc. The enterprise system can, based on the received information, and based on additional data structures generated by other parts of the organization, determine whether coordination criteria have been breached (e.g., whether scheduling needs to be updated), whether sufficiency criteria have been satisfied (e.g., whether a task has been completed with a sufficient standard of care), and whether immediate action parameters require emergency responses, etc. To provide an example, depending on the breached coordination criteria, an enterprise scheduler architecture can generate and disseminate a new action, a new plan, a new environment, a new situation, a revised schedule, etc., that can be consumed in a generated view, to enable rapid dissemination of changes.

In addition, the combination of data from various disparate sources with the data from the mobile devices in the hazardous environment by the enterprise system can enable real time decision making, including, for example, decision making about personnel scheduling (e.g., safety personnel), work execution, equipment allocations, resource allocation, etc. The combination can also enable greater accuracy in predicting safety risks, whether existing or potential. In general, the enterprise system can enable a better prediction of the consequences of certain operations, including scheduling operations.

In one aspect, a method for performing safety or industrial adjustments, wherein one or more mobile devices operate in a hazardous environment is disclosed. The method includes transmitting, from the one or more mobile devices, data structures that represent a location of the respective mobile device, wherein the one or more mobile devices transmit data sources associated with the project. The method includes receiving, by a remote system, the transmitted data structures. The method includes providing, to the remote system, one or more additional data structures associated with a project. The method includes determining, based on the data structures and the one or more additional data structures, that one or more coordination criterion have been breached. The coordination criteria are associated with adverse outcomes for the project. The method includes determining a new action to address adverse outcomes associated with the breached criterion, and generating and transmitting at least one view of the new action for approval.

In example embodiments, the one or more coordination criterion is associated with at least one of a misallocation of equipment, or a misallocation of workers.

In example embodiments, the additional data structures are data structures from other mobile devices operating in the hazardous environment of the project.

In example embodiments, the project is completed according to a first allocation, and the method further includes determining a second allocation of workers for a zone in a project. The method can include transmitting the second allocation to the one or more mobile devices impacted by the second allocation.

In example embodiments, the project is completed according to a first allocation, and the method further includes determining a second allocation of equipment for a zone in a project. The method includes assigning workers to implement the second allocation, and transmitting the second allocation to the one or more mobile devices impacted by the second allocation.

In example embodiments, the one or more coordination criteria is based on worker compliance with a first allocation. The one or more coordination criteria can be based on worker time spent at a workface, or based on worker congestion in a zone, or based on legal limitations.

In example embodiments, the at least one view includes at least one of a heat map of worker movement, a map of tasks performed, or a filter for a specific task. The at least one view can include work to be performed in a future timespan, a safety prediction or safety evaluation, or a congestion assessment of the new scheduling.

In another aspect, a system for performing safety or industrial adjustments is disclosed. The system includes one or more mobile devices and a remote system to perform any one of the methods described herein.

In yet another aspect, a computer readable medium (CRM) for performing safety or industrial adjustments is disclosed. The computer readable medium comprising computer executable instructions for performing any one of the methods described herein.

Advantages of the systems, CRMs, and methods described herein can include better coordination of resources, less use, reduced amount of time spend on coordination between units performing at the behest of the same enterprise, increased data security and retention policies, reduced generation of traffic via the ability to serve data to mobile devices.

### BRIEF DESCRIPTION OF THE DRAWINGS

Implementations will now be described with reference to the appended drawings wherein:

FIG. 1 is a block diagram illustrating an example system for incorporating mobile devices for safety and/or industrial operations.

FIGS. 2A, 2B, and 2C are each a block diagram illustrating aspects of example ingestion of information.

FIG. 3 is a block diagram of an architecture of an example analytical tool.

FIG. 4 is a block diagram of existing scheduling processes.

FIG. 5 is a block diagram of example processes according to the present disclosure.

FIG. 6 is a block diagram of existing rescheduling processes.

FIG. 7 is a block diagram of example processes according to the present disclosure.

FIG. 8 is a diagram of an example graphical user interface of a mobile device.

FIGS. 9A, 9B, 9C and 9D each show an example graphical user interface populated by an example proposed process.

FIG. 10 is a flow diagram illustrating an example method for incorporating mobile devices for safety and/or industrial operations.

### DETAILED DESCRIPTION

As used and referred to herein the term “computing resource” is not intended to be limited to a particular type of computer resource (e.g., memory, computing power, etc.), or to a particular amount of computing resource(s). The term is intended to capture resources required to implement the functionality of the device or module being described.

In many applications, including in oil and gas operations, existing safety and industrial operations can rely at least in part on poorly constructed data generated within a hazardous environment. For example, some existing practices include review of written records (possibly including manual collation of the records), review of a plurality of digital sources of data, where the act of accessing and comparing the different data sources in the respective digital or physical platforms makes the review unnecessarily complicated, cumbersome, and possibly incorrect. The different digital platforms can have different organizational schemas, further making comparison and derivative action more difficult, if not impossible. This review can also be unnecessarily labor intensive, potentially requiring individuals responsible for the data to be in the same room to explain notations to one another.

In addition, and specifically with respect to digital sources of data, the use of different data platforms for the different data can increase costs associated with implementing digital solutions, potentially impede new implementations due to the rigidity of existing solutions and generate difficulty in onboarding different or new sources of data.

Finally, digital platforms currently used can be complicated to navigate or operate. These difficulties can limit their usefulness, as less sophisticated users, or time-pressed users, can turn to different solutions. The digital platforms can also be specialized, and difficult to integrate into a larger environment that is more available, particularly on mobile phones.

To address at least some of the issues discussed above, a system, device, and method are proposed in which safety or industrial operations with one or more mobile devices operating in a hazardous environment are performed.

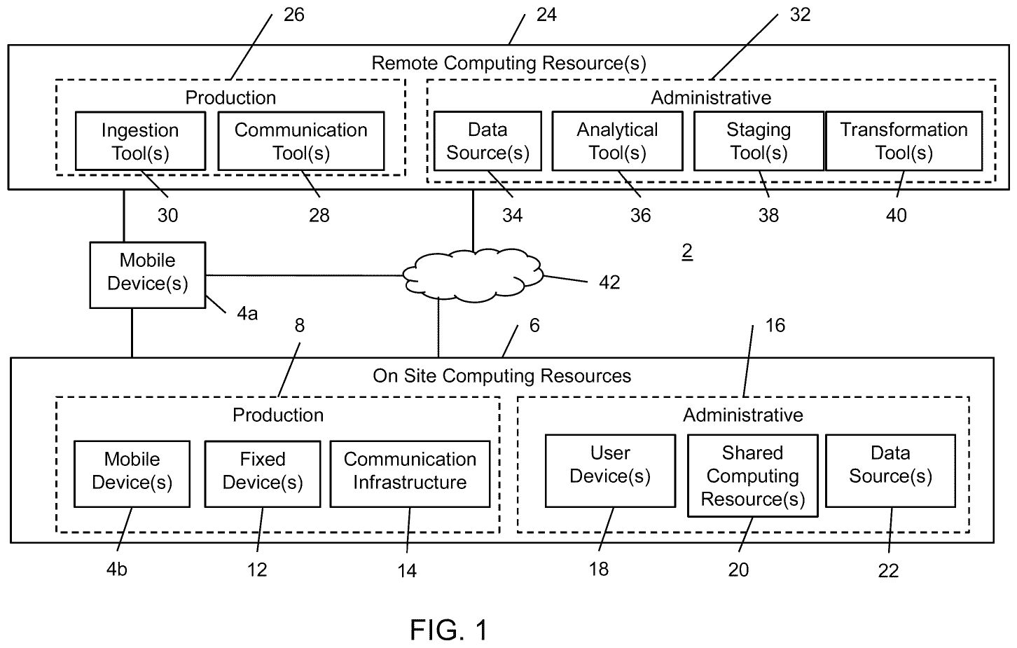

FIG. 1 schematically illustrates a system 2 utilized by an enterprise for performing safety or industrial operations with one or more mobile devices 4 operating in a hazardous environment.

The system 2 includes on-site computing resources 6 (alternatively referred to as local computing resources). The local computing resources 6 can be located on premises of the industrial operations being performed by an enterprise. It is noted that while the term “industrial operations” has been used for readability, it is understood that this term encompasses various enterprise operations, whether industrial or otherwise. Moreover, it is noted that while only a single set of local computing resources 6 is shown, it is contemplated that a plurality of local computing resources 6 can be connected to the system 2. For example, local computing resources 6 can include different subsections or zones for a particular production site, including the shown production zone 8 and the administrative zone 16. It is understood that the described zones are illustrative; various zones can exist within these illustrative zones (e.g., plant 1, or walkway 1, etc.), or differently defined zones can be implemented.

The production zone 8 can include one or more mobile device(s) 4b to generate data about one or more hazardous zones of the production zone 8. The mobile devices 4b can have functionality that is either inherently restricted to a particular premises associated with the local computing resources 6 (e.g., a purpose-built mobile device for reporting safety data with a limited range), or intentionally limited to a location (e.g., a mobile sensor device configured to connect only to a secure network provided on site). The production zone 8 can include fixed device(s) 12, such as fixed sensors, and a communication infrastructure to connect the mobile devices 4b and/or the fixed devices 12 to other components of the system 2. For example, some mobile devices 4b may be configured to receive sensor data from fixed sensor devices 12 and transmit that data to other components of the system 2 via the communication infrastructure 14.

Computing resources of the production zone 8 can be adapted to survive and operate in hazardous environments. For example, the production zone 8 can be an oil and gas production area where: hazardous accidents and hazardous situations are possible because of the operations undertaken there, or where environmental conditions are themselves hazardous, etc.

Previously, computing resources of the production zone 8 were limited, and the devices themselves or the communication infrastructure 14 was unable to facilitate communication as between (1) devices in the production zone 8, or (2) between those devices and the system 2. For example, modern mobile phones were unable to be used in production facilities as they could not safely operate within the environment therein or were unable to be operated when the necessary safety equipment was worn. As a result of advancements, the devices of the production zone 8 are now capable of communicating, via the communications infrastructure 14, with other components of the system 2.

The administrative zone 16 of the local computing resources 6 can include one or more user devices 18 (e.g., a desktop computer, a mobile device, etc.), one or more shared computing resources 20 (e.g., a server), and one or more data source(s) 22 (e.g., a database).

In example embodiments, the system 2 includes mobile devices 4a operating other than in the local computing resource production area. For example, these mobile devices 4a can be employee mobile devices which are used off-site.

The system 2 can include or utilize remote computing resources 24. The remote computing resources 24 are illustratively shown partitioned to serve the different local zones (i.e., the production remote computing services 26 and the administrative remote computing resources 32); it is however understood that these partitions are illustrative, and various configurations are contemplated. The remote computing resources 24 can be configured to serve a plurality of onsite computing resources 6.

The remote computing resources 26 that service the production environment can include one or more communication tools 28 which can be used to facilitate communications with various systems of the local computing resources 6. For example, the communication tools 28 can include certain application programming interfaces (APIs) to communicate with legacy production fixed devices 12. In another example, the communication tools 28 can include tools to enable secure connection with a particular mobile device 4b application, where the communication tool enables the use of the particular encryption scheme. In another example, the communication tool can be a server that hosts instances of an application which communicates with a related application on the local computing resources 6 (e.g., a Microsoft® application server).

The remote computing resources 26 can include one or more ingestion tools 30 (hereinafter referred to in the plural, for ease of reference). The ingestion tools 30 can perform a variety of operations to communications received by the remote computing resources 26 from the local computing resources 6. The ingestion tools 30 can be used to create data to send to different staging tools 38 (and related data sources 34). The ingestion tools 30 can perform operations to enhance the data received from the production zone 8, such as adding timestamps, including identifiers associated with the source of the data, etc. Various modes of ingestion are contemplated. For example, certain ingestion tools 30 can be used for batch ingestion from particular components (e.g., one set of ingestion tools 30 for data received from mobile devices 4), whereas other ingestion tools can be used and to stream data from other components of the computing resources 6 (e.g., another set of ingestion tools 30 for data received from the shared computing resources 20).

Referring now to the remote computing resources 32 shown as associated with the administrative zone, these resources 32 can include one or more data sources 34, one or more analytics tools 36, one or more staging tools 38, and one or more transformation tools 40.

The data sources 34 can include various iterations of received data (e.g., data received in a landing container, transformed data, curated data, etc.). Various data sources 34 can be used for different types of data, or for different partitions of enterprise operations (e.g., separate data sources 34 can be used for production data, for administration data, with separate data sources being used for different types of administrative data).

Different levels of access to the data sources 34 may be granted to various parties. For example, the landing container data may be configured to only be accessed by data scientists, whereas the curated data may be accessed by various operational staff of an enterprise, etc.

The one or more staging tools 38 can be used to perform a variety of operations on data ingested by the ingestion tools 30 and stored in the data sources 34. The operations can include standardizing the data to a particular desired format, adding data to increase transformation with various other data sets (e.g., generating a new column in the data representative of the source and, potentially populating that column), preparing the data to be analyzed by particular analytical tool 36 (e.g., an analytic tool 36 can require JSON files), etc.

Different staging tools 38 can be used for different local computing resources 6, or different partitions of the local computing resources 6. For example, one set of staging tools 38 can be used for certain data generated on the administrative zone 16 (e.g., administrative data such as human resources data, projected project staffing data, etc.), whereas a different set of staging tools 38 can be used for data generated in production (e.g., sensor data, worker safety, etc.). A third set of staging tools 38 can be used for data received from another local computing resource 6 from a different production site.

One or more transformation tools 40 can be used to facilitate processing of the data (e.g., stored in data source 34) by the analytics tools 36. The transformation tools 40 can be used to coordinate within one instance of a local computing resource 6 (coordinate the administrative and the production data for a particular location automatically), or to coordinate between similar local computing resources 6 (e.g., to coordinate and consolidate data from various similar production facilities), etc. For example, transformation tools 40 can be used to generate a new container (e.g., a new data source 34) which includes relevant data from a first site and a second site, combining not only the production site data but the associated administrative data, which various data sets exist in different formats (e.g., owing to legacy systems, different service providers for different subsystems, different legal requirements such as joint ventures, etc.).

The remote computing resources 24 also include one or more analytics tools 36 that process transformed data to serve a response to a requesting user (e.g., a user using a mobile device 4a), or to automatically serve a response. The analytics tools 36 can be provided by a third party, such as the provider of the remote computing resources 24 (e.g., AWS™ analytics tools), purpose built by the enterprise utilizing the computing resources 24, or a combination of the two.

The analytics tools 36 can be used to trigger the staging tools 38, the transformation tools 40, or other parts of the remote computing resources 24 and/or the local computing resources 6. For example, if a particular user wishes to analyze data of a particular subset of production facilities, the analytics tool 36 can be used to trigger the generation of a data source 34 (e.g., a curated data set responsive to a query), which may require the use of the staging tool 38 in the transformation tools 40 to be generated.

One or more components of the computing systems 24 and the local computing resources 6 can be connected by a communications network 42. The communications network 42 can be a wireless network, a wired network, or a combination of a wireless and wired network. The communications network 42 can include various communication technologies including, but not limited to, shorter distance communication technologies (e.g., Bluetooth™), longer distance communication technologies (e.g., telephone and cellular data networks), implemented through various means (e.g., optical fibers), etc.

The system 2 as described herein may be used to transition from an on-premises to remote (e.g., cloud) enterprise data storage and analysis implementations to monitor production safety and allocations. In addition, the system 2 can potentially reduce technical debt (e.g., the amount of investment needed in terms of expertise needed to maintain legacy on premises systems) or reduce costs.

The system 2 as described herein may support horizontal (e.g., the incorporation of multiple computing resources 6) and vertical scaling (e.g., incorporation of multiple computing resources 6 with the remote computing resources 24) which may potentially ease issues faced currently with utilizing one database for executing staging, ETL (extract, transform, load) and KPI (key performance indicators) generation processes. The system 2 as described herein may be able to support future KPIs, including not only KPIs that respond to technological changes, but KPIs that incorporate new methodology to capture existing implementations (e.g., KPIs that incorporate machine learning teachings).

The system 2 as described herein may be configured to store data up to one year before executing deletion of such data, for example, to comply with regulatory or other business requirements.

The system 2 as described herein may be able to support introducing new types of mobile devices 4, or new configurations of existing mobile devices 4. For example, existing mobile devices 4 may be configured to provide location data as x, y coordinates (relative coordinates), while new devices or new configurations may be able to provide x, y, z coordinates.

In addition, by centralizing data in the remote computing resources 24, the disclosed system 2 can enable various means of analyzing enterprise-wide data or data from similar sites via the data sources 34. For example, the remote computing resources 24 can be accessed with a web application with data entry capability for the analytics. Similar to the mobile device 4 functionality, the system 2 as described herein may be able to support existing application functionality, and support new or revised application functionality.

The system 2 as described herein may be used to provide real time, or near real time analytics. In addition, the system 2 may be used to provide automated, or at least partially automated analytics.

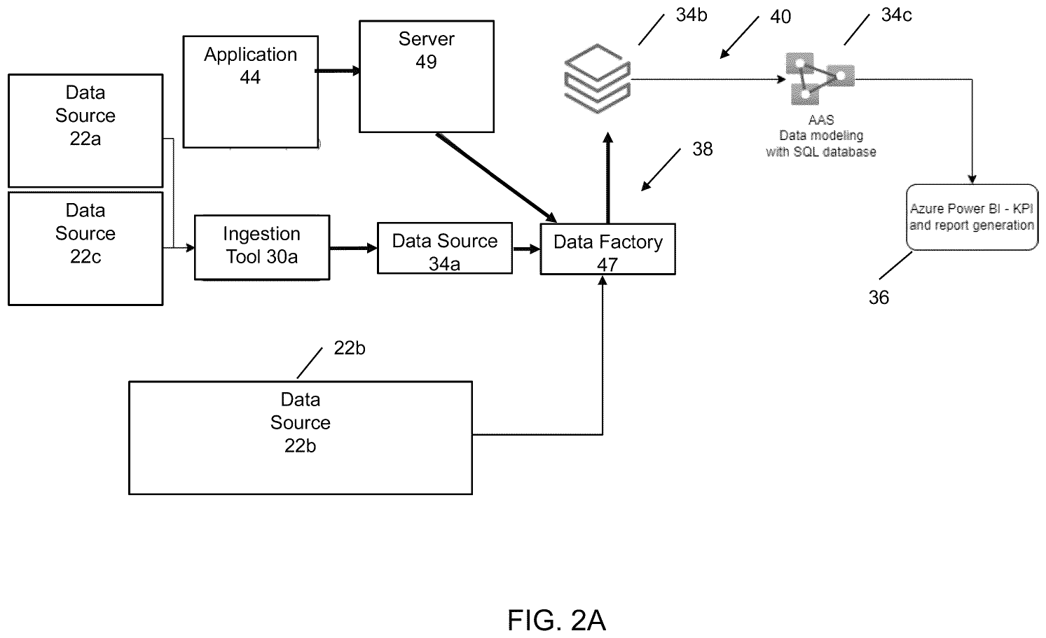

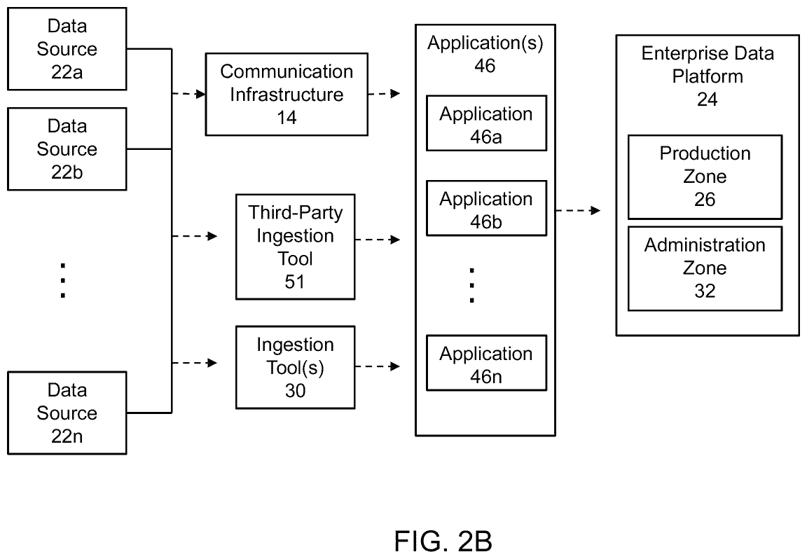

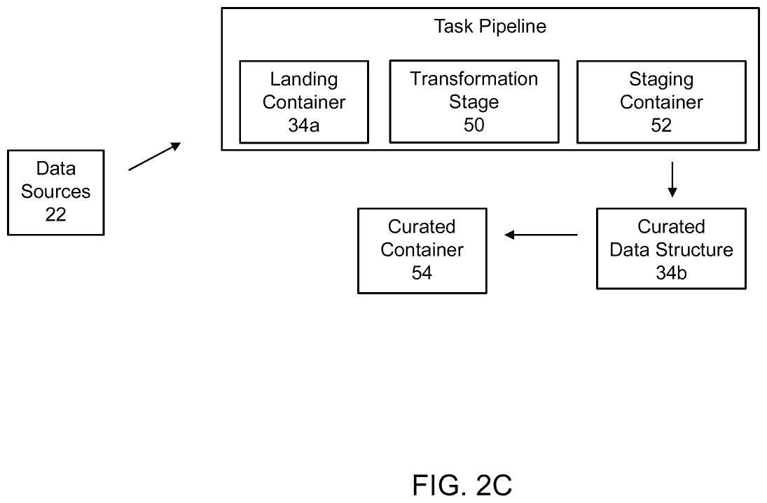

Reference is now made to FIGS. 2A, 2B and 2C, which each show block diagram representations of aspects of an example ingestion process.

A plurality of data sources 22 that contain data that is to be provided to remote computing resources 24 are shown. Each of the shown data sources 22 can be stored according to a different schema. For example: the data source 22a can be a production database that stores data in a first format, or according to a first system (e.g., data stored in with a CDMS system), etc.; the data source 22c can be stored in a second format, or according to a second system (e.g., an Airbox™ data structure), which data source 22c can be jointly managed as a result of a joint venture; the data source 22b can be an administrative data source which can include data that is stored according to yet another scheme or system (e.g., human resource (HR) data can be stored in a first scheme, financial information can be stored with another scheme, etc.). Another data source (not shown) can be used to provide notifications, workorders and operations information from a particular production site.

In the shown embodiment, the data source 22a and 22c are provided to a remote computing data source 34a via an ingestion tool 30a. The ingestion tool 30a can be an application programming interface (API) that is designed to integrate data onto the specific cloud computing platform (e.g., a Mulesoft™ API product). The ingestion tool 30a can be configured to specifically ingest data in the format present on the relevant data source 22a, can provide the data to the data source 34a in batch or stream the data (e.g., in real time, such as real time shift start and end times), etc.

The data ingested into the data source 34a is provided, alongside data from the data source 22b to a data factory 47. The data factory 47 can process the received data into the data source 34b (e.g., a curated data structure) with at least one of the staging tools 38, or the transformation tools 40, or a combination of the two. For example, the data factory 47 can use the transformation tools 40 to generate a curated data source 34b at least in part reconciling the data from the various different data sources.

Examples of staging tool 38 and transformation tool 40 operations are set out below:

A staging tool 38 can be used to get rid of duplicates in the ingested data. For example, each different data source may duplicate a worker or contractor identification number.

A staging tool 38 can be used to convert data from a first format into a second format. For example, employee records stored in a first format (e.g., time in and time out in MM/DD/YYYY) can be converted to a different format, which different format may be consistent with another data source 22 that is ingested, or the data can be used to generate another feature (e.g., total time worked), etc. In another example, certain parameters can be added to data from a first format (e.g., a product ID), by adding zeros.

A staging tool 38 can be used to assign data from a particular data source 22 an ID or other marker, to facilitate remediation efforts or other tracing type operations. In example embodiments, the staging tool can assign markers to identify a variety of properties, including time data was received, etc.

A staging tool 38 can be used to check for consistency of data being ingested. For example, if the different data sources 22 include related data (e.g., data source 22b can include an invoice, data source 22a can include times worked), the related data can be compared to determine if it agrees. In the instance of a lack of agreement between the related data, the staging tool 38 can generate an alert.

A staging tool 38 can be used to generate a representation of the relevant zone (e.g., the production zone 8), such as determining its area (e.g., define the boundaries), or to relate data to the zone data (e.g., place an employee working on a product within a zone), etc.

The data factory 47 can be used to generate various curated data sources 34b. That is, the data factory 47 can generate a first curated data source 34b used by business analysts, a second curated data source 34b used to respond to requests by operations staff, etc.

Various stages of curated data sources 34 can be generated. For example, the curated data sources 34b can be further processed by one or more of staging tools 38 and transformation tools 40 to generate an analytics data source 34c, where the analytics data source 34c is at least in part configured to interface with the analytics tools 36. For example, the analytics database can include data in a format (e.g., a Structured Query Language (SQL) database) that is accepted by analytics tools 36, include features expected by analytics tools 36, etc.

In example embodiments, the analytics data source 34c can be generated with a staging tool 38 and/or transformation tool 40, which tools can include or be in communication with a data model (not shown) which specifies interrelationships between data. The data model can, for example, specify that the analytics data source 34c is generated by aggregating data into features defined by the previous 15 days, the previous 30 days, etc. The data model can, for example, specify that the analytics data source 34c is generated by generating data to identify different zones for particular production environment (e.g., based on project mapping data), a new feature for every employee that identifies which zone was worked (e.g., based on employee location data), generate a feature that captures the amount of time each employee was in a particular zone (e.g., based on employee timing and timeout data), generate a new feature that describes the number of absent days (e.g., based on project scheduling data and employee timing and timeout data), and so forth.

The analytics data source 34c is used by the analytics tools 36 to monitor safety, resource allocation, emergency responses, situation awareness, project status, etc. Different analytics data sources 34c can be generated for different analytics tools 36, or a single analytics data source 34c can be used for a plurality of analytics tools 36.

In at least some example embodiments, the data factory 47 is configured to receive additional data from an application 44 (e.g., a web application, or an application connected to a data source 22, etc.). For example, workers may enter data via an example web application instance of an application 44 where a dedicated application has failed, or they are otherwise unable to connect to location dependent applications that store directly to on-premises data sources 22.

The application 44 can store any data provided thereto with a remote server 49 (e.g., external to the enterprise controlling the computing resources 24), and thereafter provide same to the data factory 47. The application 44 can also be an application that is used to receive real-time data. As shown, the data received via application 44 can be real-time data provided directly to the data factory 47 for curation without the ingestion tools 30a. This arrangement may beneficially enable data received from the application 44 to bypass queues associated with the ingestion tools 30a and retrieval from the data source 34a.

Referring now to FIG. 2B, another block diagram representation of an example ingestion process is shown.

In the shown example, the data from the data sources 22 is provided to one or more applications 46. The data can be provided via ingestion tool(s) 30, via a third-party ingestion tool 51, or via the communication infrastructure 14. The applications 46 can be configured to store any data received from the data sources 22a (which may be temporary data stores on the mobile devices 4, or aggregators thereof), in the remote computing resources 24.

FIG. 2C shows another block diagram representation of an example ingestion process. In FIG. 2C, the data sources 22 provide data, via transmission, to a landing container (data source 34a). The data in the landing container proceeds to the transformation stage 50, where data is transformed with the one or more transformation tools 40. The transformed data (the result of the transformation stage 50) is thereafter prepared for consumption in a staging container, which may apply one or more staging tools 38. The resulting curated data structure 34b is thereafter provided to a container 54 of curated data structures, which container 54 can be used to generate analysis data sets for the analysis tools 36.

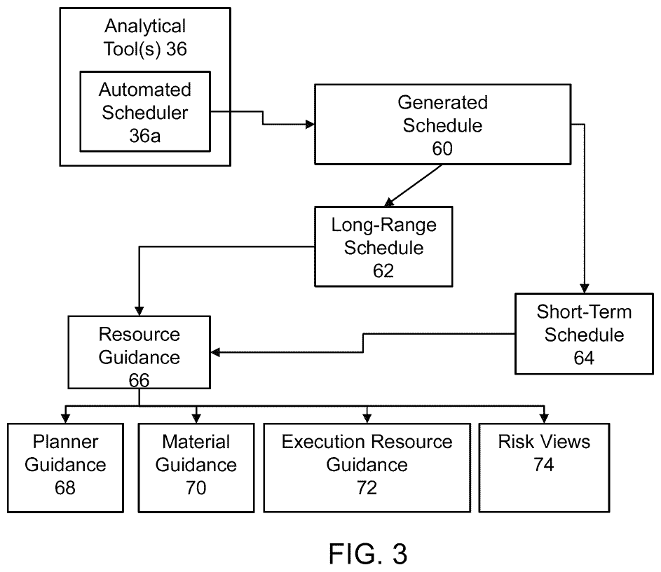

Referring now to FIG. 3A, a block diagram of an scheduler tool 36a is shown, which is an example of an analytics tool 36. The scheduler tool 36a can be a scheduling tool which can process the curated data in the container 54 to generate at least one of a long-term schedule 62 and a short-term schedule 64. In example embodiments, the short-term schedule 64 is defined as a schedule for enterprise resources for the next 15 days, whereas the long-term schedule 62 identifies resource allocation for the next 90 days. The schedule(s) can include a detailed listing of work-orders required to complete the project. That is, the scheduler 36a can be configured to list the required tasks, the estimated times, resources needed to complete the task, the nature of the work being performed (which may be generated based on a preconfigured list), etc.

In example embodiments, the scheduler tool 36a is configured to generate the long-term schedule 62 or the short-term schedule 64 according to a variety of optimization parameters. For example, the scheduler 36a can generate schedules which include the least down time for workers, schedules which include the more cost-effective use of certain capital equipment, a less costly schedule based on third-party vendor pricing (e.g., where outside parties are used to perform at least some of the work, with the schedule avoiding overtime), a schedule which is completed in a shorter amount of time, etc.

The short-term schedule 64 and the long-term schedule 62 can include a variety of components that have been weighed by the scheduler 36a to guide enterprise resource allocation (shown as resource guidance 66). The schedules can include guidance as to how to allocate workers (shown by planner guidance 68), guidance for which materials are needed to complete the work (shown as material guidance 70, which can include material which is exhausted during operations), execution resource guidance 72 for how to allocate nonperishable materials required for the operations (e.g., machinery, reusable networking equipment, etc.).

The scheduler 36a can also be configured to generate one or more risk assessments of either generated schedule. The risk assessments can reflect risk from multiple aspects of the generated schedules, including logistical risk and safety risk. For example, the scheduler 36a can be configured to assign a risk value to having personnel be assigned work consecutive days without break (e.g., where, for example, absences become more statistically likely after 5 consecutive workdays), scheduling risk associated with transportation delays for materials arriving to the production zone, the likelihood of certain weather events delaying transportation of materials or people, the likelihood that weather conditions will impact the schedule (e.g., rainstorms which prevent work being done outdoors, the likelihood of rainy days delaying bottleneck work, etc.).

Safety risks assessed can, for example, include the risk associated with congestion, the remaining useful life of the equipment being used, the availability of safety personnel, the historical track record of adverse events by individual workers or contractors, the likelihood of an adverse event given expected weather conditions, the likelihood of adverse events in any particular phase of a project, etc.

These risk assessments can be generated by the risk views module 74 shown in FIG. 3A.

In at least some example embodiments, the schedules, allocations, or risks generated by the scheduler 36a are connected with or provided to a mapping application. For example, a planning team may be able to graphically look at the work that is being planned out seven or more days in advance superimposed on a relevant map. The map can be publicly available, or an internally generated map. The map can be two dimensional, or three dimensional, and include a variety of features. Mapping of information provided by the scheduler 36a can enable plant turnaround or maintenance teams to visualize how many workforce(s) will be present, which entity (e.g., contractor) the workforce is associated with, in which area work will be performed by the workforce, what work is planned. The mapping can also enable early determination of gaps in the planning (e.g., in response to receiving real time data from mobile devices 4, or contractors). The scheduler 36a can enable the safety prediction to be overlayed on a map (e.g., as a filter parameter), such that the work planned by the planning team for the subsequent period (e.g., seven or more days in advance) can be seen. Safety team(s) interacting with the map may be able to better plan for areas where an elevated risk is predicted.

The scheduler 36a can be configured to provide the long-term schedule 62 to one or more users associated with forecasting, and/or scheduling. The long-term schedule 62 can be further edited by these individuals. In example embodiments, the long-term schedule 62 includes a description of maintenance schedules for projects which have already been completed.

The short-term schedule 64 can be provided to one or more users overseeing workers and/or third-party vendors. The short-term schedule 64 can therefore be used to ensure that all parties understand expectations associated with their work, and to avoid the confusion of having schedule information located in different places. The short-term schedule 64 can also be used as a reference to be provided to an execution tool (e.g., a Microsoft™ PowerApps application).

The scheduler 36a can use historical data to create notifications based on comparisons of the scheduled work to similar completed jobs/tasks done. For example, the notification can include an indication that the previous work history required a certain number of resources, had a certain variance, etc. In one example, the historical data for tower work around wall thinning can indicate that approximately 150 people are required, and existing planning indicates that only 100 workers have been allocated to a similar job, the scheduler 36a can tag the existing job, and generate a notification (e.g., a yellow flag). The notification can be overlayed on the map, generated as a separate message (e.g., an email), etc.

In addition, in at least some example embodiments, the scheduler 36a can suggest mitigation efforts. For example, the scheduler 36a can recommend that additional safety staff be put on standby, for different parameters for the work (e.g., changing a scheduling of work, reducing the number of nighttime hours worked, reducing the amount of work performed by employees on consecutive shifts, etc.). Over time, the scheduler 36a can learn the effectiveness of different mitigation efforts, leading to better mitigation strategies or new standards for scheduling. For example, the scheduler 36a can be trained without input safety measures, such that the scheduler 36a reviews the historical data to determine the more effective mitigation efforts.

The scheduler 36a can also use historical data to create safety evacuation plans or notifications. For example, based on data from the data sources (e.g., worker card swipes, location data from mobile devices, camera data, etc.), which data can be historical or real time data, the scheduler 36a can generate a notification(s) (e.g., in the form of a dashboard) that can support the evacuation process at plant areas. For example, the scheduler 36a can be used to schedule evacuation paths, from a plurality of paths, for workers (or a particular area) based on their location, and the capacity of the particular evacuation path.

The scheduler 36a can be in communication with one or pre-existing resources which provide inputs required to assess the risk. For example, the scheduler 36a can be in communication with one or more configuration files of the enterprise which include legal requirements associated with worker scheduling. The scheduler 36a can be in communication with existing forecasting software (e.g., SAP software) which is used to forecast material needs for a particular project. The scheduler 36a can also be in communication with a configuration data service that includes business rules for scheduling (e.g., safety regulations or best practice preclude certain work being done at night, business rules require assuming a particular number of deficient materials for more accurate forecasting, etc.). In one example, a business rule can include limitations on the number of overtime hours worked in a particular duration, where overtime work may be more likely to generate an adverse safety event.

The schedule(s) generated by the scheduler 36a can potentially avoid instances of a lack of understanding how many enterprise resources there are, where said resources are, what the resources are being used for, how many tasks these resources have assigned to them, etc. Overcoming previous limitations, the scheduler 36a can prioritize workers to the highest value work resulting in a savings of waste and inefficient allocation. The previous implementation where supervisors/coordinators obtained schedules by work center and then managed task assignments verbally, via spreadsheets and pieces of paper, resulting in loss of field time during which they should be focused on ensuring work safety and quality, can be avoided.

Delays in getting confirmations into on-premises data sources 22 (e.g., SAP/Primavera) can also be avoided. That is, the scheduler 36a can be used to generate views of daily progress compared to an existing schedule to help maintain cohesiveness on site.

In addition, the scheduler 36a can be configured to generate new schedules in response to one or more new events. For example, the scheduler 36a, as a result of processing curated data which can include real time data, can be configured to generate new schedules to re-route materials in the event of a shortage (or to predict a shortage in advance), can generate new tasks to move workers to zones which can accommodate more parallel work, or to reschedule employees to different tasks in the event, for example, that a relevant permit has not been granted. Generating updated schedules can facilitate streamlining a reallocation processes, as parties become aware of their expected tasks faster, and understand how expectations have changed. For example, with devices 4b capable of receiving scheduling information, evacuations can be improved by reducing the need for employees to communicate without ambiguity in potentially stressful situations.

The use of the scheduler 36a with curated data in the container 54 can also potentially avoid maintenance scheduling tools that are inadequate for day-to-day execution (e.g., certain information may be stored via monitoring tools, while other information may be stored via project management tools, etc.). These isolated or siloed tools, which can be specialized for a limited purpose, may be unable to integrate to a reference data source or provide the data cleanly to analytics for optimization.

The scheduler 36a can be configured to generate log files for audit purposes. For example, the scheduler 36a can generate a log of the data relied upon to generate worker allocations, a log of when the relevant enterprise submitted data for consumption (e.g., contractors submitting data late may result in inefficient scheduling), etc.

The scheduler 36a, as a result of the architecture contemplating receiving data from various data sources, can be configured to onboard new data sources (e.g., from a different project site) relatively quickly. The data from the new source can be ingested without requiring downtime of other existing data sources 22.

The scheduler 36a can also benefit from new data sources to increase its accuracy. For example, data available from a new joint venture can be provided as part of training the scheduler 36a such that insights from the newer projects can be incorporated into planning for existing projects. In addition, in at least some example embodiments, the benefits gleaned from the new projects can be shared without breaching confidentiality provisions. The scheduler 36a can incorporate machine learning models that extract patterns from underlying raw data to generate a trained machine learning model, where the trained machine learning model can be applied to other similar data without the need for the confidential underlying data.

The scheduler 36a can be configured to provide different scheduling data to different applications. For example, a first application can be an application used for long term scheduling, a second application used by a sourcing department can be provided with information related to equipment (both capital and perishable), another application can be used to monitor human resources, etc.

It is understood that, while certain actions have been described as being performed by the scheduler 36a, a different analytic tool 36 can be used to perform similar functionality. That is, it is contemplated that other than one scheduler 36a performs all the functionality described herein, or that the scheduler 36a is an umbrella tool that incorporates a plurality of tools 36 (e.g., an emergency response tool, an action tool, etc.).

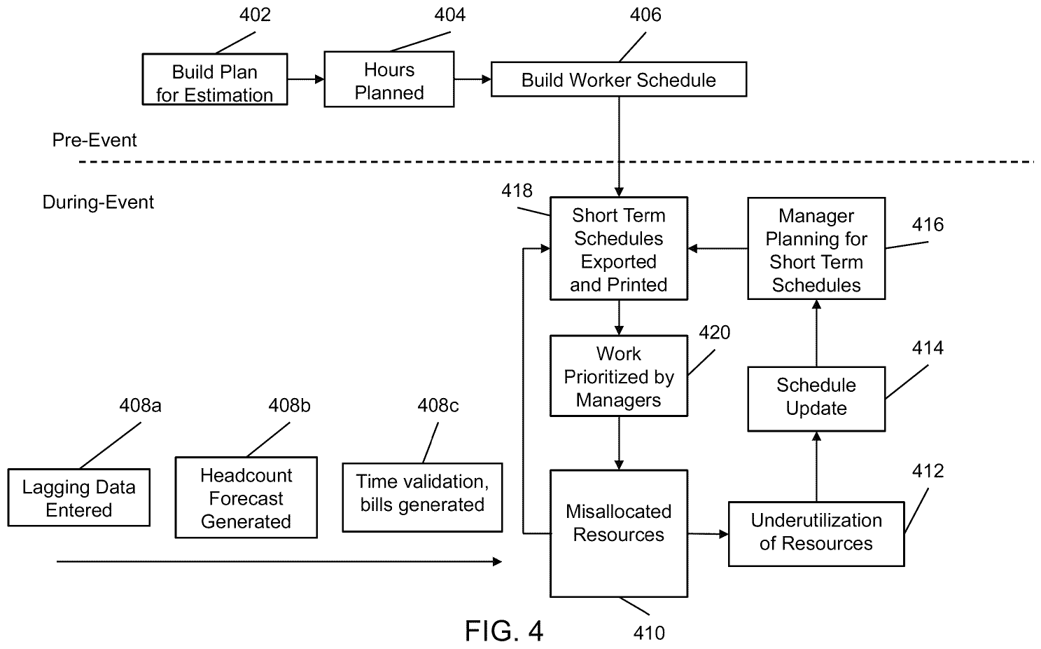

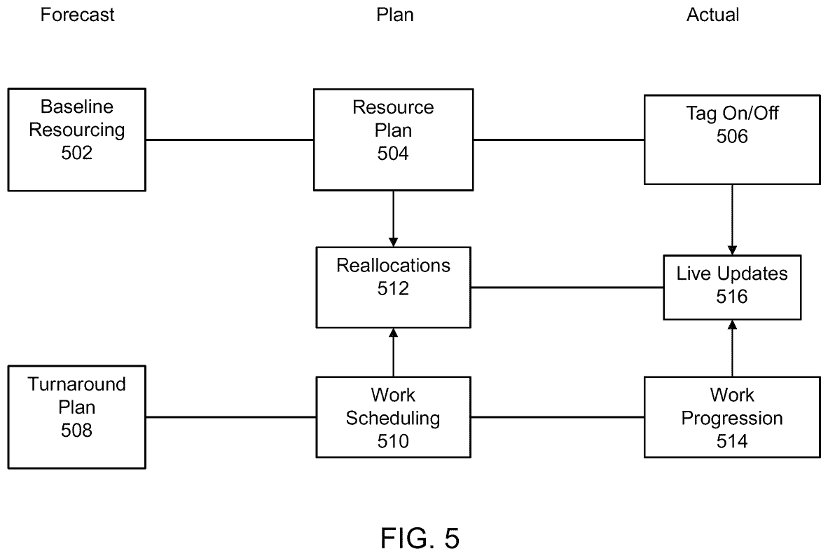

Referring now to FIGS. 4 and 5, FIG. 4 shows a block diagram of a method of creating and maintaining action-based schedules, such as a turnaround plan. A turnaround plan, in relation to hydrocarbon production operations, can include halting extraction and/or production of hydrocarbons or hydrocarbon derived products in order to assess the state of existing equipment, conduct repairs, etc. Turnaround plans can include halting or deactivating equipment in stages, or all at once, etc. FIG. 5 shows an example proposed process, in contrast to FIG. 4.

At block 402, a plan is generated so that estimation of resources and manpower can begin. At block 404, worker hours are planned. At block 406, a schedule is built in a scheduling application. At block 418, the generated schedules are printed and distributed for work. At block 420, managers determine priorities based on the provided schedules. The prioritization by managers based on printed schedules leads to misallocated resources, shown as block 410. These resources are known to be misallocated only after information at blocks 408a, 408b, 408c, regarding work completed, materials used, and worker hours, are input, respectively, at the end of the day. At block 412, analysis is performed to determine misallocated resources. The misallocation, for example, can include having idle workers or materials, or having overworked workers, etc. At block 414, the managers again confer with the previous schedules and the new knowledge of misallocated resources to determine a revised schedule (i.e., a new schedule, as shown by block 418), as shown at block 416. Thereafter, the cycle of revising schedules can continue, where the schedules are updated based on lagging information.

In contrast, FIG. 5 shows a process to generate and disseminate a new action, a new plan, a new environment, a new situation, a revised schedule, etc., by a tool 36.

At block 502, the tool 36 (e.g., a scheduler 36a can handle scheduling components of block 502) processes the data in the curated data source 34 to plan an action, a new plan (e.g., a new resource plan), a new environment (e.g., designating locations for particular equipment, operations, etc.), a new situation (e.g., generating a new emergency action plan), a schedule(s) (e.g., long-term schedule 62, or short-term schedule 64, or both), etc. The generated action can represent a baseline (i.e., planned in a first instance) resourcing of workers, equipment, materials, etc.

At block 504, a resource plan (e.g., a worker resource plan, or an equipment resource plan, etc.) is generated based on the output of the tool 36 in block 502. The resource plan of block 504 can include granularity not present in the planning of block 502. For example, the resource plan of block 504 can include granularity such as the particular service provider and the specific type of materials.

At block 506, the mobile devices 4 (including any mobile devices attached to equipment, such as mobile machinery, or mobile devices connected to workers, or mobile devices connected during shipping to perishable materials, etc.) are tracked.

At block 516, live updates are generated based on the location information received from the mobile devices in block 506.

At block 508, a turnaround plan is generated by a tool 36. Similar to block 502, the turnaround plan of block 502 can be a turnaround plan at first instance. For example, the turnaround plan can include a scheduled shut down of designated equipment or operations for a determined duration based on a variety of factors, including, for example, an amount of production predicted by the tool 36 (e.g., turnaround plans can be based on time, an amount of hydrocarbon produced, expected loading cycles, etc.), an assumed availability of different contractors, etc.

At block 510, the turnaround plan generated in block 508 can be used to generate work scheduling in block 510. For example, the turnaround plan can specify a number of boilermakers needed, inspectors needed, etc., their dependencies on one another (e.g., inspectors are scheduled after or during work being completed) to complete the turnaround plan in the defined duration.

At block 512, the tool 36 can determine reallocations of workers, materials, equipment, etc., in response to inputs challenging initial assumptions (e.g., approvals for certain actions only received at a later date, requiring rescheduling of turnaround), or in response to the live updates received in block 516 (e.g., shortage of workers to complete inspection), etc.

In contrast to FIG. 4, the updated information (which information can be real-time updates, such as the shown block 516 representing live updates) provided to the tool 36 can be used to generate a revised turnaround plan of block 508, or a revised baseline of block 502 in response to new events. The new events can include defects in existing work, discovering conditions different than expected conditions, etc.

The tool 36, based on determined plans for blocks 502 or 508, and considering the new events, can determine one or more actions to adjust to the new events. For example, the tool 36 can generate a new or revised turnaround plan to have resources already deployed (or idle and available) rerouted to accommodate the revised turnaround plan. In another example, the tool 36 can generate a new inspection procedure where the quality of work has been deficient despite the existing inspection protocol. In another example, the tool 36 can revise later stages of plans generated in blocks 502 and 508 to adapt to new events.

The tool 36 can continually monitor live updates from block 516, which can be populated based on work progress events resulting from block 514 (e.g., workers entering their progress in through the mobile device 4), and iteratively revise or regenerate the plans of block 502 or 508.

In example embodiments, the work is tracked with a dedicated application (hereinafter referred to as the Real Time Communication Application (RTCA), which may be, for example, application 46a). The RTCA can be instantiated on each mobile device 4 on site (or within a production zone). The RTCA of each mobile device 4 can connect with the remote computing resources 24 to enable serving of data to the mobile device 4 of scheduling updates. The ability to provide data for consumption by various parties with the RTCA can enable the monitoring of the progress towards planned work. As a result of the RTCA, workers may be able to reduce the number of meetings, emails, and time discussing updates. Instead, the information ingested by the computing resources 24 is provided to interested parties via the RTCA, such that managers of various disparate parties are kept informed of reallocations that could impact them.

The RTCA can be configured to be robust and scalable, such that it can be implemented not only for mobile devices 4 of workers of the enterprise, but also third parties such as contractors, providing a single reference source. That is, the RTCA can remove the need to have workers in the same physical location, while providing similar coordination benefits. For example, any updated turnaround plan 508 generated as a result of information from the RTCA (or otherwise) can also be provided to all instances of the application, facilitating rapid distribution and uptake of new scheduling or reallocations.

The RTCA can also reduce the amount of time needed by workers to enter certain zones to retrieve data (e.g., data that may be sensitive, or governed according to a restrictive data privacy policy). That is, workers can avoid entering administrative locations to enter information (thereby reducing the footprint of the administrative zone), enabling potentially more efficient worktimes (travel time is reduced), more robust scheduling (no ad hoc paper copies to lose), reduced time spent in meetings for updates (e.g., in some instances up to 2 hours per day of reduced management coordination meetings), etc.

The RTCA can be used in conjunction with a Real Time Planning Application (RTPA) that is used to enter data for ingestion by the remote computing resources 24, which data can be used to generate action plans, work plans, turnaround plans, etc.,

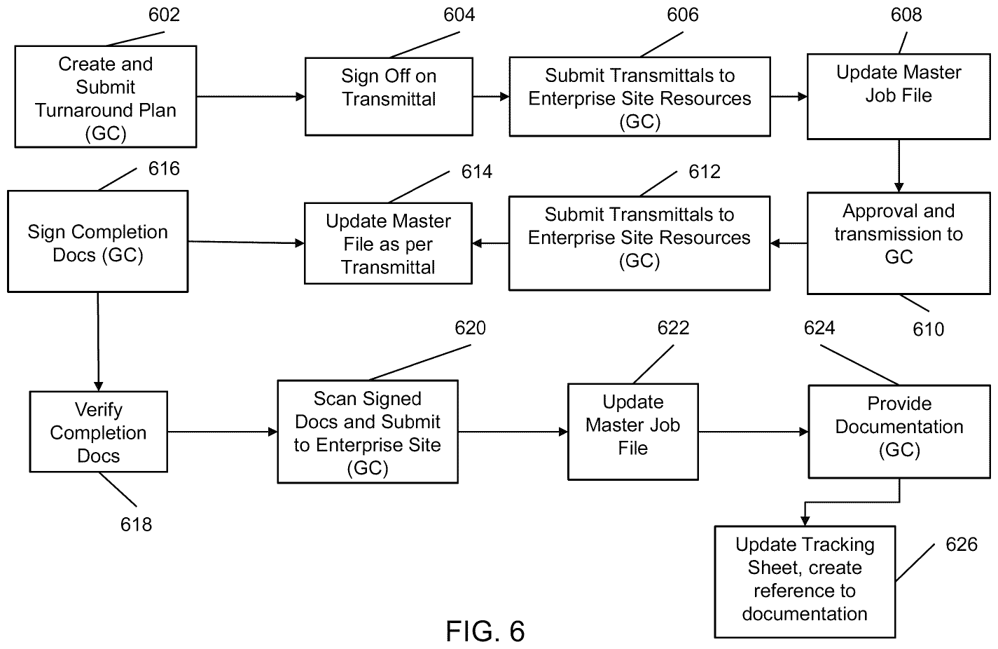

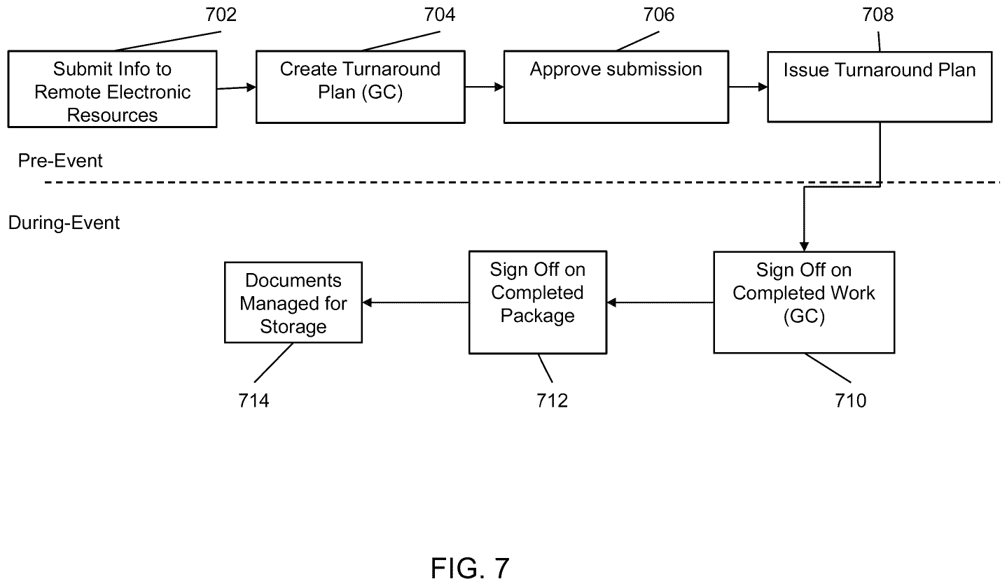

FIGS. 6 and 7 each show a block diagram of a method of creating and tracking plans such as turnaround plans, with FIG. 6 showing an example existing method, in contrast to the proposed method of FIG. 7 wherein an action tool 36 generates or revises the plan in part. It is noted that in FIGS. 6 and 7, the actions of two separate parties are shown: a general contractor (denoted by the abbreviation GC) and the enterprise undertaking the work. For simplicity, FIGS. 6 and 7 shall refer to a turnaround plan; it is understood that the tool 36 can be used to prepare plans other than a turnaround plan.

Referring now to FIG. 6, at block 602, a GC submits a turnaround plan to the enterprise. At block 604, the enterprise can provide confirmation of the submission of the turnaround plan. It is not unusual for block 602 and block 604 to be performed on site, such that the process may be carried out entirely on paper between respective representatives of the GC and the enterprise. At block 606, the documents associated with the earlier blocks are submitted to the enterprise.

At block 608, the enterprise updates a master job file to which the turnaround plan pertains. At block 610, the enterprise can evaluate the submitted turnaround plan, and determine whether to approve it. At block 612, the GC can submit additional documentation during performance of the turnaround plan to the enterprise. At block 614, the enterprise can update its existing master job file to reflect the correspondence received from the GC in block 612.

At block 616, the GC can sign off on the turnaround plan once completed and submit the relevant documentation to the enterprise. At block 618, the enterprise can verify completion of the remedial work. Block 618 can include an inspection and generating certain paperwork on site.

At block 620, the GC can scan the signed off documents (i.e., the documents indicating completion), and the verification documentation related to the turnaround plan and transmit same to the enterprise. At block 622, the enterprise can update the master job file with documentation received from block 620. At block 624, the GC can provide all documentation related to the turnaround plan (e.g., for record-keeping purposes). At block 626, the enterprise can update the master job file to reflect the perceived information.

Referring now to FIG. 7, an example of a proposed process for implementing turnaround plans is shown.

At block 702, the GC or the enterprise submits information to the remote resources 24 to initiate a turnaround plan submission process. Submission can be made to an application which is accessible by either the enterprise or the GC (e.g., Microsoft SharePoint), such that the information can originate from either party.

At block 704, the GC submits a turnaround plan for consideration. The turnaround plan can be created in the RTPA, which can at least in part be template driven. For example, the templates can require identification of a task of a master task list that the turnaround plan relates to contact information for the GC, identification of relevant individuals to address the turnaround plan to, supporting documentation, the type of work required to complete the plan, urgency associated with the turnaround plan, etc. The templates can require input to be in a certain format, for ease of ingestion by the remote resources 24, etc. For example, the templates can be continually updated such that no ingestion tools 30 are required to ingest data received from the RTPA.

In example embodiments, the information provided in block 704 is provided to the scheduler 36a to evaluate the risk (logistics risk, safety risk, or otherwise) associated with the proposed turnaround plan, or the scheduler 36a generates a turnaround plan based on submitted information. The scheduler 36a can also be used to update the existing schedules to accommodate any generated or proposed turnaround plans.

At block 706, the enterprise approves a turnaround plan. As a result of the information being provided to a RTPA, the turnaround plan can be served to relevant reviewing authorities, and approved in a short time span (e.g., in near real time).

At block 708, the RTPA issues the turnaround plan as part of a new schedule. The RTPA can communicate with the RTCA to ensure that the turnaround plan is provided to relevant individuals on site.

At block 710, the GC monitors and signs off on work performed according to the turnaround plan in the RTPA. Generation of new inputs by the GC can be configured to automatically be submitted to the relevant enterprise reviewing authority, such that existing requirements to document interactions, and submit that documentation for approval to the enterprise can be omitted.

At block 712, when the turnaround plan is completed, and based on the documentation of the completed work at block 710, the enterprise can sign off on the completed turnaround plan package.

At block 714, the enterprise signed off documentation package is provided to a data source (e.g., data source 34) for persistent storage.

The process shown in FIG. 7 can potentially reduce the number of emails, communications, and time costly steps of existing turnaround plan processes. In addition, or an alternative to, the method shown in FIG. 7 can streamline communications between multiple parties. For example, the process proposed in FIG. 7, multiple contractors can be integrated into the RTPA, in real time, as a single source of truth, removing uncertainty associated with discreetly stored data, potentially stored in different fashions (e.g., paper, digital, etc.).

As a result of a more streamlined process, standards can be developed that can be applied to a larger area (e.g., a regional approach in favor of a side-by-side approach). In addition, the additional data ingested by the RTPA can be used to fuel further insights with the analytical tools 36. For example, the scheduler 36a can be used to identify where earlier inspections can be required given historical data that turnaround plans are more likely to be required for a particular task, or particular environmental conditions, etc.

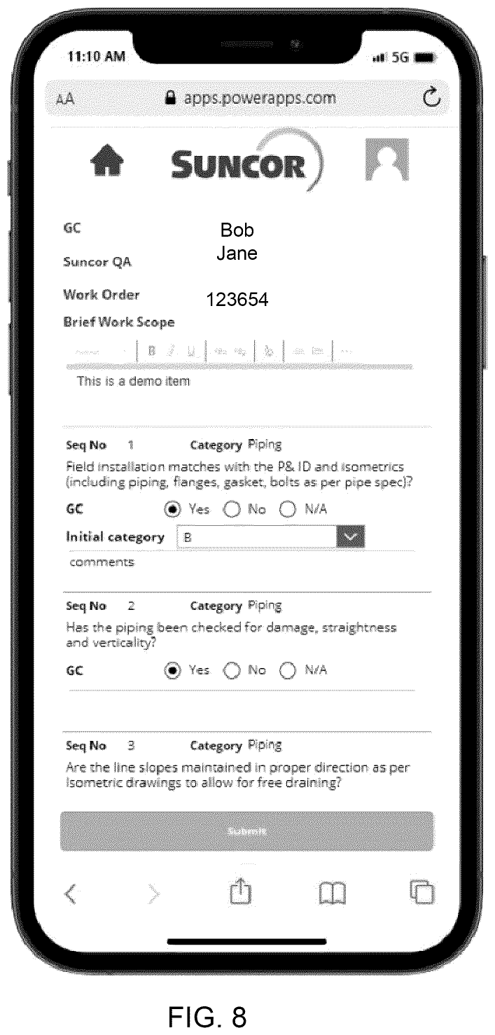

FIG. 8 shows an example graphical user interface of a real planning application implemented on a mobile device.

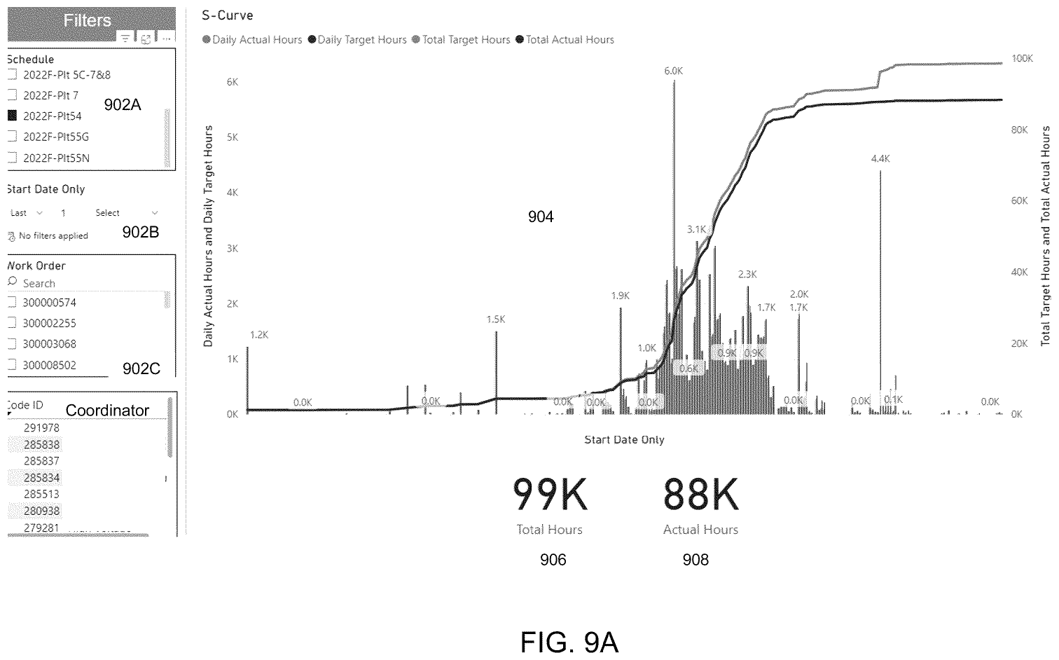

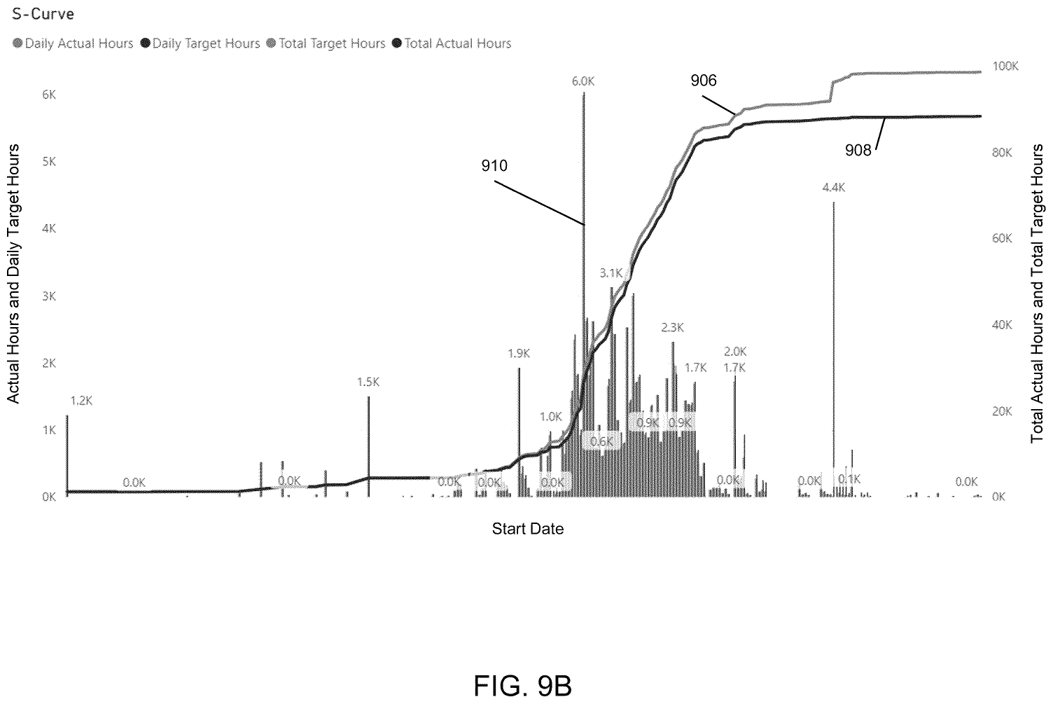

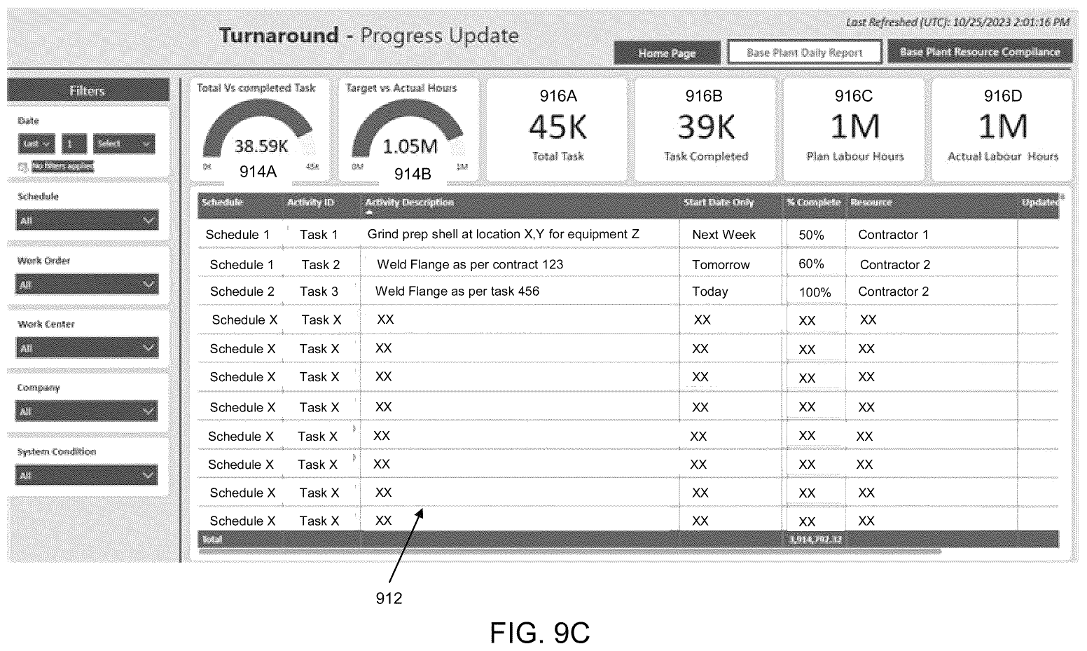

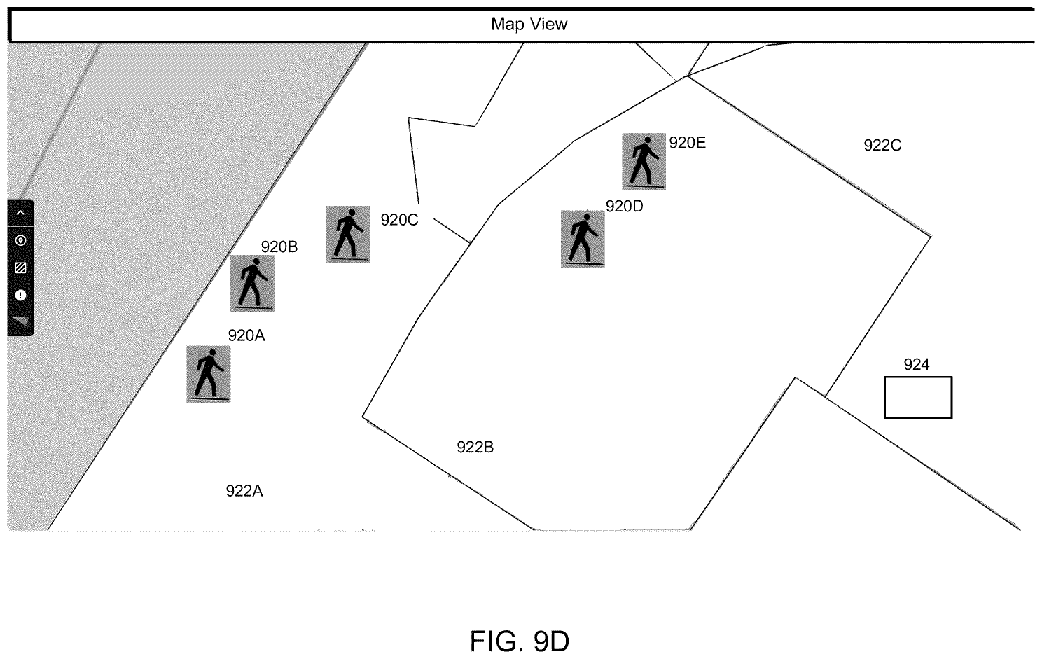

FIGS. 9A, 9B, and 9C each show an example graphical user interface populated by an example proposed process.

FIG. 9A, for example, can be used by a reviewer to track the progress of an existing turnaround plan for a particular location. In the shown embodiment, the GUI includes filtering dimensions (the shown filters 902A, 902B, and 902C) to facilitate reviewing, including a filter 902a to filter according to a particular schedule 902A (e.g., showing sub-schedules associated with a master schedule), a filter 902B to filter according to a work order, and a filter 902C to filter according to a coordinator. Various filters, and combinations of filters, are contemplated.

The filtered data structures can be plotted in a visual representation 904 (shown as a bar and line graph), one or more key indicators (e.g., the shown key performance indicators 906, 908 of total hours and actual hours, respectively). FIG. 9B shows a clarified image of the representation 904, where the indicators 806, 908 are plotted over time based on individual instances of the respective indicators, shown as bars 910.

FIG. 9C shows another example visual representation of the data structures. In FIG. 9C, a more granular view of the data structures may be accomplished. A table 912 shows the individual entries (filtering is possible, as demonstrated by the left-most column in FIG. 9C) used to populate the indicators, alongside different representations of the indicators including the graphical indicators 914A, 914B, and the indicators 916A, 916B, 916C, 916D which show different selected indicators. The various indicators can be configured, such that the GUI shows customized information.

FIG. 9D shows an example image generated according to the disclosure. In FIG. 9D, the position of workers is mapped (e.g., based on the device 4 provided geolocation). Mapping can include showing the worker positions (e.g., positions 920A, 920B, 920C, 920D, 920E) generally, or overlayed on a map including customizations such as zones (e.g., the shown zones 922A, 922B, 922C). The mapping of the worker positions can be used to generate emergency evacuation plans for the workers based on the number of workers present in a zone, the geometry of the zone, the location of the zone relative to an adverse incident, the number of exits in a zone, etc. In at least some example embodiments, the location of materials can also be tracked (e.g., via tags), as shown by equipment position 924.

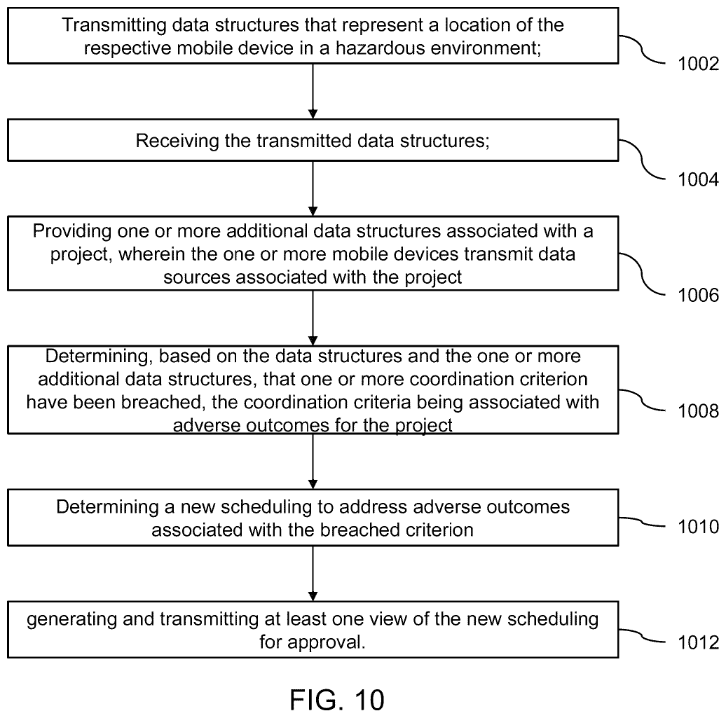

FIG. 10 is a flow diagram of an example method for performing safety or industrial adjustments, wherein one or more mobile devices operate in a hazardous environment. For ease of illustration, FIG. 10 shall refer to elements discussed in relation to preceding figures, and any such references are understood to not limit the scope of the disclosure of FIG. 10.

At block 1002, the mobile devices 4 transmit data structures that represent the location of the respective mobile device 4. In at least some example embodiments, the transmitted data structures can also include data in addition to, or in place of, the location of the respective mobile device 4. For example, the data structures can be a data structure associated with a submission for a turnaround plan from a GC. The data structures can include data associated with sensors proximate to the mobile device 4 (e.g., environmental sensors attached to a worker or installed at a stationary location on site, which transmit data to the computing resources 24 via the mobile device 4 (e.g., a phone) of the worker).

Different mobile devices 4 can transmit data with different data structures. For example, sensor mobile devices for can transmit data according to a first data structure, whereas data provided by an on-site manager to a centralizing application (e.g., such as the RTCA, or the RTPA, described herein) can be transmitted in the second data structure.

At block 1004, a remote system (e.g., remote computing resources 24) receives the transmitted data structures. The remote system can receive the data structures indirectly (e.g., via resources in the administrative zone 16), or directly (e.g., via the communication infrastructure 14 of the production zone 8).

At block 1006, one or more additional data structures related to the project are provided to the remote system. The additional data structures can include sensor data (which may be provided by the same mobile device 4 that provides the first data structure, with the mobile device 4 acting as a conduit for that information to arrive at the remote computing resources 24), project management data (e.g., as provided by the RTPA), input from administrators, planners, or other personnel which can manage a project. The additional data structures can be in the same format as the data structures provided by the mobile devices 4 (e.g., provided by a centralizing application), or otherwise (e.g., provided by legacy data storage centers).

At block 1008, a determination is made as to whether one or more coordination criteria have been breached. The coordination criteria are associated with one or more adverse outcomes for the project. The determination is made based on the provided data structures and the one or more additional data structures.

Coordination criteria can be established before the project, be evaluated in real time to reflect expected progress, etc. Different coordination criteria can be used for the short-term schedule 64, and the long-term schedule 62. The coordination criteria for a first project can be informed by the coordination criteria of similar past projects. For example, the scheduler 36a can implement machine learning models to learn from past projects to determine coordination criteria applicable to a current project.

The coordination criteria can be associated with misallocation of equipment on the production site. The coordination criteria can include a desirable level of inventory for perishable materials, a working time associated with particular piece of equipment, a location of equipment and/or perishable materials (e.g., the equipment will be sitting idle for a few days, or exposed to weather risk, where it can be better positioned in a different zone of the project), and so forth.

In another example, the coordination criteria can be associated with misallocation of worker resources. Misuse of worker resources can be measured based on an existing schedule (e.g., the short-term schedule 64), where an insufficient number of workers are assigned to critical tasks, or certain workers are ignoring the provided existing allocation. Misuse of worker resources can be measured based on a safety score generated by the scheduler 36a. For example, safety personnel can be assigned to zones of the project less likely to experience adverse events than compared to other zones of the project, leading to misallocation. Misallocation of worker resources can be measured based on worker time spent at a workface. For example, the coordination criteria can be based on measuring the amount of time individual workers are present at a workface (i.e., operable equipment required to complete the project), and if the location data indicates below the required amount of engagement, coordination criteria can be breached.

The coordination criteria may be used to determine gaps in the existing documentation, to avoid overcorrection. For example, documentation which underrepresents the amount of time spent on the tool can lead to overcorrection. To provide an example with more particularity, if a worker's mobile device 4 in Plant A shows them to be at a workface, but there is no data as to when that worker picks up tools, or handles equipment, then the time at the workface is assumed to contribute to work required. In this scenario, proposed new schedules that do not incorporate the work time may be flagged as a breach of coordination criteria.

In another example, coordination criteria can be based on levels of predicted congestion in a predefined zone. For example, the scheduler 36a can generate a prediction of congestion (e.g., it may be difficult to inspect completed work if additional work is ongoing adjacent to the work, or it may be difficult to bring in the required materials through a common pathway, etc.). Before the project begins, or in real time, coordination criteria based on congestion criteria (e.g., a range of an acceptable number of workers in a particular pathway) can be established that, if breached, indicates likely slowdown in the work and/or a dangerous environment. If the data structures provided by the mobile devices 4, or the additional data structures, indicate that there is increased congestion at a particular location (e.g., adverse conditions slowed the performance of a first phase of work, which can result in congestion if the second phase of work is commenced), the coordination criteria can be breached.

In another example, coordination criteria can be based on legal limitations. For example, if the mobile device 4 location data indicates that a worker has been working for more than the legal limit for allowable over time, the associated coordination criteria based on legal limitations can be breached. In another example, the coordination criteria can be based on the number of people allowed in the particular work zone.

In another example, coordination criteria can be based on safety scores or predictions. For example, the coordination criteria can be based on a predicted safety score generated by the scheduler 36a. The scheduler 36a can generate a safety prediction based on environmental factors in the work being performed (or scheduled to be performed), which can be updated to incorporate updated environmental conditions (e.g., work that includes elevated works can be evaluated as dangerous in windy conditions).

The coordination criteria can be defined by a single value (e.g., no more than x amount of overtime hours), a range of values (e.g., a first coordination criteria range can lead to notifications, where another range can result in rescheduling), etc.

The coordination criteria can be used in conjunction with emergency response criteria, sufficiency criteria, or these other criteria can be used without the coordination criteria, or various combinations of criteria can be used.

Sufficiency criteria can be used to determine whether existing work has been completed satisfactorily. For example, the sufficiency criteria can include a requisite amount of inspector approvals. The sufficiency criteria can also include a ratio of inspector approvals to inspections, etc.

Emergency response criteria can include the detection of an adverse event, the detection of an existing emergency action plan, and determining whether the action plan has been satisfied. For example, in the event of a fire, the action plan can include indicating that mobile devices 4 within a certain radius should be notified of the adverse event, and the relevant action plan (e.g., evacuation plan). Individuals designated for specific tasks (e.g., a fire marshal) can be automatically reminded of their required functions via their mobile device 4, such that the mental load on workers in times of stress is reduced at least in that they do not need to remember what the plan was, and in that the notification can provide information on next steps. The emergency response criteria can be continually monitored with the location of the devices 4 to update the plan, if required.

At block 1010, new scheduling is generated to address adverse outcomes associated with the breached criterion. The new scheduling can include new allocations of the workforce, the equipment, or perishable materials.

At block 1012, at least one view of the new scheduling is generated. The at least one view can include a graphic user interface (GUI) which can include a heat map representing various parameters represented by different colors. For example, the heat map can show personnel movement over a selected time span to indicate congestion.

The view can also include a GUI which is able to be manipulated according to one or more view parameters. For example, the GUI can enable filtering of the relevant data in the remote computing resources 24 according to a particular project(s), according to particular tasks of the project, to movement in a particular zone. The GUI can show the number of workers entering and leaving the production site (e.g., for breaks, shift check ins, etc.), the identity of the workers, the tasks that the workers are expected to be performing, and documentation associated with the particular tasks, etc.

In at least some example embodiments, the GUI can show the new scheduling over a selected future time span. For example, the GUI can display work planned over the next week, month, etc. To add particularity, the GUI can show that 12 pipefitters and 8 scaffolders are scheduled to be in a certain zone and provide the option of a selection to provide further details of the work they are associated with. The GUI can also show potential risks, as discussed with respect to FIG. 5.

In at least some example embodiments, the GUI shows predicted mass movement for different days. The prediction can be generated by the scheduler 36a, consuming ingested work orders (e.g., turnaround plans), determining where workers will likely be, and where the congestion is likely to occur.

The GUI can also be configured to receive input. For example, the GUI can be configured to input new availability of certain workers (e.g., a contractor is delayed in arriving), resulting in the generation of yet another new schedule. The input can relate to the coordination criteria, such that stricter coordination criteria can be employed.

The new scheduling can be approved by a reviewer. In example embodiments, the view is transmitted to a relevant authority to enable rapid oversight of scheduling.

Optionally, the new scheduling can be the result of a turnaround plan (for example, as compared to a new scheduling based on environmental conditions). As a result, the new scheduling can include a second allocation of workers in a project. The second allocation can be transmitted to the one or more mobile devices 4 associated with workers impacted by the second allocation, to enable rapid dissemination of new scheduling expectations by affected parties. The second allocation can also be provided via a notification, including a tactile notification (e.g., a buzzing), and auditory notification (e.g., a beeping or other sound), or a visual notification (e.g., a flashing, or the generation of a notification message), etc.

In some example embodiments, the second allocation includes an allocation for equipment different than the allocation of first instance. The method can include assigning workers to implement the second allocation of equipment (e.g., to move the equipment to a new location), and transmitting the second allocation to one or more devices 4 associated with workers impacted by the second allocation. In this way, worker and equipment resources can potentially be coordinated in a faster approach.

For simplicity and clarity of illustration, where considered appropriate, reference numerals may be repeated among the figures to indicate corresponding or analogous elements. In addition, numerous specific details are set forth to provide a thorough understanding of the examples described herein. However, it will be understood by those of ordinary skill in the art that the examples described herein may be practiced without these specific details. In other instances, well-known methods, procedures, and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are for example only. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method for performing safety or industrial adjustments, wherein one or more mobile devices operate in a site, the method comprising:
transmitting data structures from the one or more mobile devices, wherein the one or more mobile devices transmit data sources associated with a project;
receiving, by a remote system, the transmitted data structures;
providing, to the remote system, one or more additional data structures associated with a project;
determining, based on the data structures and the one or more additional data structures, that one or more coordination criterion have been breached, the one or more coordination criterion being associated with adverse outcomes for the project;
determining a new action to address adverse outcomes associated with the breached criterion; and
generating and transmitting at least one view of the new action for approval.

2. The method of claim 1, wherein the one or more coordination criterion is associated with a misallocation of equipment.

3. The method of claim 1, wherein the one or more coordination criterion is associated with misallocated workers.

4. The method of claim 1, wherein the additional data structures are data structures from other mobile devices operating in the site of the project.

5. The method of claim 1, wherein the project is completed according to a first allocation, the method further comprising:
determining a second allocation of workers for a zone in a project;
transmitting the second allocation to the one or more mobile devices impacted by the second allocation.

6. The method of claim 1, wherein the project is completed according to a first allocation, the method further comprising:
determining a second allocation of equipment for a zone in a project;
assigning workers to implement the second allocation;
transmitting the second allocation to the one or more mobile devices impacted by the second allocation.

7. The method of claim 1, wherein the one or more coordination criterion is based on worker compliance with a first allocation.

8. The method of claim 7, wherein the one or more coordination criterion is based on worker time spent at a workface.

9. The method of claim 7, wherein the one or more coordination criterion is based on worker congestion in a zone.

10. The method of claim 7, wherein the one or more coordination criterion is based on legal limitations.

11. The method of claim 1, wherein the at least one view comprises at least one of a heat map of worker movement, a map of tasks performed, or a filter for a specific task.

12. The method of claim 1, wherein the at least one view comprises work to be performed in a future timespan, or a safety prediction or safety evaluation, or a congestion assessment of the new action.

13. The method of claim 1, wherein the data structures represent a location of the respective mobile device.

14. A computer readable medium storing computer-executable instructions for performing safety or industrial adjustments, the computer readable medium comprising computer executable instructions for:
transmitting data structures from the one or more mobile devices, wherein the one or more mobile devices transmit data sources associated with a project;
receiving, by a remote system, the transmitted data structures;
providing, to the remote system, one or more additional data structures associated with a project;
determining, based on the data structures and the one or more additional data structures, that one or more coordination criterion have been breached, the one or more coordination criterion being associated with adverse outcomes for the project;
determining a new action to address adverse outcomes associated with the breached criterion; and
generating and transmitting at least one view of the new action for approval.

15. A system for performing safety or industrial adjustments, the system comprising:
one or more mobile devices in a site configured to transmit data structures;
a remote system configured to receive the transmitted data structures and one or more additional data structures associated with a project, wherein the one or more mobile devices transmit data sources associated with the project, the remote system configured to:
determine, based on the data structures and the one or more additional data structures, that one or more coordination criterion have been breached, the one or more coordination criterion being associated with adverse outcomes for the project;
determine a new action to address adverse outcomes associated with the breached criterion; and
generate and transmit at least one view of the new action for approval.

16. The system of claim 15, wherein the project is completed according to a first allocation, and the remote system is further configured to:
determine a second allocation of workers for a zone in a project; and
transmit the second allocation to the one or more mobile devices impacted by the second allocation.

17. The system of claim 15, wherein the project is completed according to a first allocation, and the remote system is further configured to:
determine a second allocation of equipment for a zone in a project;
assign workers to implement the second allocation of equipment; and
transmit the second allocation to the one or more mobile devices impacted by the second allocation.

18. The system of claim 15, wherein the one or more coordination criterion is based on worker compliance with a first allocation.

19. The system of claim 15, wherein the one or more coordination criterion is associated with misallocation of equipment.

20. The system of claim 15, wherein the data structures represent a location of the respective mobile device.
